(19) United States
(12) Patent Application Publication
(10) Pub. No.: US 2014/0035354 A1
(43) Pub. Date: Feb. 6, 2014

(54) BRAKE ACTUATION UNIT FOR A MOTOR VEHICLE BRAKE SYSTEM AND MOTOR-PUMP UNIT FOR PROVIDING A VACUUM FOR A BRAKE ACTUATION UNIT OF A MOTOR VEHICLE BRAKE SYSTEM

(71) Applicant: Continental Teves AG & Co. OHG, Frankfurt (DE)

(72) Inventors: Michael Wirtz, Wiesbaden (DE); Holger Marschner, Oberursel (DE); Rudolf Platzer, Frankfurt (DE); Martin Semsch, Maibach-Butzbach (DE); Martin Christov, Dresden (DE)

(73) Assignee: Continental Teves AG & Co. OHG, Frankfurt, DE (US)

(21) Appl. No.: 14/052,948

(22) Filed: Oct. 14, 2013

Related U.S. Application Data
(63) Continuation of application No. 13/820,205.

(30) Foreign Application Priority Data
Sep. 15, 2010 (DE) 10 2010 040 838.7
Mar. 22, 2011 (DE) 10 2011 005 886.9

(51) Int. Cl. B60T 13/52

(52) U.S. Cl. CPC B60T 13/52
USPC 303/12

(57) ABSTRACT

The invention relates to a brake actuation unit for a motor vehicle brake system, a vacuum brake booster and a motor pump unit which is provided for supplying a vacuum and comprises a pump connected to the vacuum brake booster and an electric motor driving the pump. According to the invention, an additional sound absorbing element is provided in the connection between the vacuum brake booster and the pump in order to lower the sound level in the vehicle interior.

### CROSS REFERENCE TO RELATED APPLICATIONS

This is a continuation of application Ser. No. 13/820,205, filed Mar. 1, 2013, which is the U.S. National Phase Application of PCT International Application No. PCT/EP2011/065997, filed Sep. 15, 2011, which claims priority to German Patent Application No. 10 2010 040 838.7, filed Sep. 15, 2010, and German Patent Application No. DE 10 2011 005 886.9, filed Mar. 22, 2011, the contents of such applications being incorporated by reference herein.

### FIELD OF THE INVENTION

The invention relates to a brake actuation unit for a motor vehicle brake system, having a vacuum-operated brake booster and having a motor-pump assembly provided for generating negative pressure, comprising a pump which is connected to the vacuum-operated brake booster and comprising an electric motor which drives the pump, and to a motor-pump assembly for generating negative pressure for a brake actuation unit of a motor vehicle brake system.

### BACKGROUND OF THE INVENTION

For the provision of negative pressure (vacuum) for a pneumatic brake booster, the interior space of which is divided into at least one vacuum chamber and one working chamber, use is made of vacuum pumps which suck residual air from the vacuum chamber and discharge said residual air into the atmosphere. In the automobile industry, for this purpose, use is generally made of vane-type pumps or pivoting-vane pumps. These exhibit high friction owing to their operating principle and must be lubricated in order to attain an acceptable service life. Vacuum pumps which have vanes and which are driven by the internal combustion engine of the motor vehicle are therefore connected to the oil circuit of the internal combustion engine. It is nevertheless necessary for a significant fraction of the power output by the internal combustion engine to be expended for driving a pump of said type. This is the case even when the vacuum in the chamber to be evacuated has already been fully generated. It is therefore expedient for the vacuum pump to be operated using electrical energy and to be activated only when the absolute pressure in the vacuum chamber rises above a predetermined value.

Furthermore, in vehicles with electric and/or hybrid drive, the vacuum pump cannot, or intermittently cannot, be driven by the internal combustion engine. Electrically driven vacuum pumps are therefore used in such vehicles.

Providing such an electrically driven pump with, or connecting such an electrically driven pump to, a lubricant circuit would entail disproportionately high expenditure. Therefore, only dry-running vacuum pumps are feasible for use in motor vehicles with brake systems with an electrically driven vacuum pump. For this purpose, in vane-type pumps, use is made of the self-lubricating material graphite, from which the vanes are, with great expenditure, manufactured with the required precision. Efforts are thus being made to use a diaphragm pump for the electrical provision of brake vacuum.

A generic brake actuation unit having a motor-pump assembly is known for example from DE 10 2007 005 223 A1, which is incorporated by reference. In the automobile industry, very high demands are made with regard to the acoustic comfort of the motor vehicle components, and robust, durable pumps with very low noise emissions are demanded from suppliers. To meet said demands, it is the case in the known motor-pump assembly that the outlet ducts in the working chamber covers and in the pump housing are arranged such that air displaced out of the working chambers is conducted into an interior space, which surrounds the crank drive, of the pump housing. Furthermore, an air outlet unit is provided which permits a quiet discharge of the air from the interior space through diversion of the air. The interior space, also referred to as the crank chamber, thus serves as a silencer chamber, because the discharged air is not conducted directly into the atmosphere. By means of the diversion of the air in the air outlet unit, it is possible for the noise level to additionally be significantly lowered, such that discharge noises are virtually eliminated.

During the operation of the motor-pump assembly, however, undesired noises may also occur in the vacuum hose, which noises can be amplified yet further by the brake booster and transmitted into the vehicle interior space.

The increased use of vehicles with electric drive also increases the demands made with regard to acoustics on the brake actuation unit and on the motor-pump assembly.

### SUMMARY OF THE INVENTION

An aspect of the present invention provides a brake actuation unit having a motor-pump assembly, and a motor pump assembly, which make allowance for the increasing demands with regard to acoustic comfort.

This aspect is achieved according to the invention for a brake actuation unit and for a motor-pump assembly of the stated type by means of a further silencer element provided either (i) in the connection between the vacuum-operated brake booster and the pump, or (ii) directly at a vacuum inlet of the pump, in order to lower the sound pressure level in the vehicle interior space.

### BRIEF DESCRIPTION OF THE DRAWINGS

The invention is best understood from the following detailed description when read in connection with the accompanying drawings. Included in the drawings is the following figures:

FIG. 1 shows a diagram of a first exemplary embodiment of a brake actuation unit according to the invention and of a motor-pump assembly according to the invention;

FIG. 2 shows a diagram of a second exemplary embodiment of a brake actuation unit according to the invention and of a motor-pump assembly according to the invention and

FIG. 3 shows a diagram of a third exemplary embodiment of a brake actuation unit according to the invention and of a motor-pump assembly according to the invention.

### DETAILED DESCRIPTION OF THE PREFERRED EMBODIMENTS

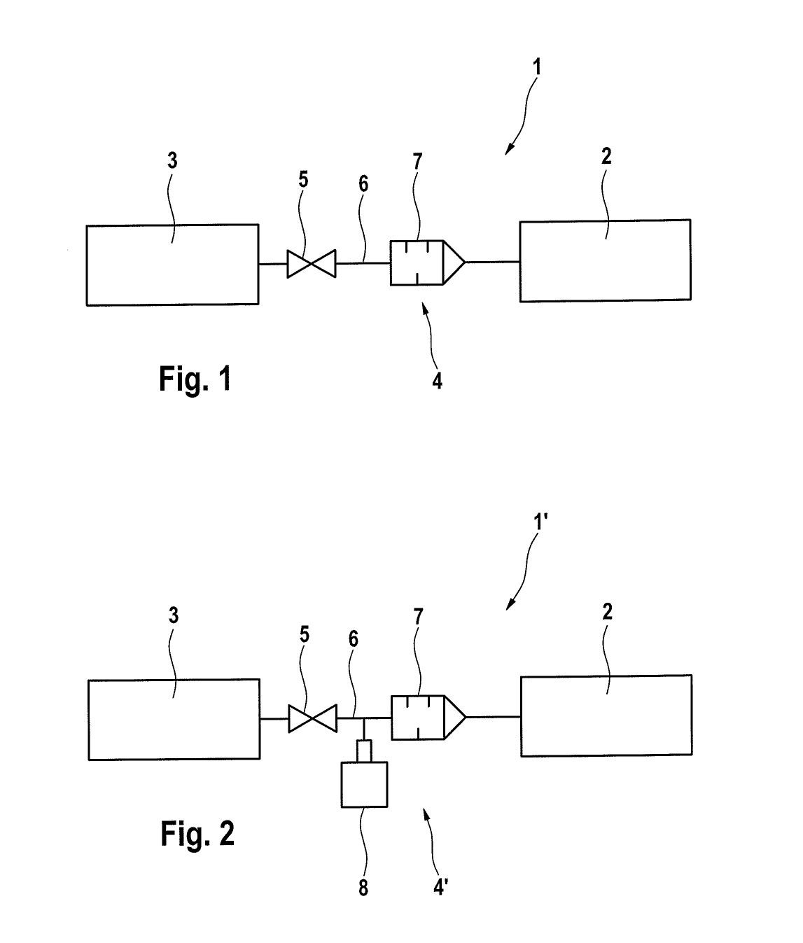

FIG. 1 shows a brake actuation unit 1 for a motor vehicle brake system, having a vacuum-operated brake booster 2 and having a motor-pump assembly 3 provided for generating negative pressure. The motor-pump assembly 3 comprises a pump, which is connected to the vacuum-operated brake booster 2 via a connecting line 6, and an electric motor which drives the pump.

The pump (not shown in any more detail) is for example provided in the form of a diaphragm pump with a pump housing and with at least one working diaphragm which, together with a working chamber cover, delimits a working chamber and which can be moved by means of a crank drive, wherein the working chamber is assigned an inlet duct with inlet valve and an outlet duct with outlet valve.

The pump is ideally in the form of a double diaphragm pump with two opposite working diaphragms.

To make allowance for the high demands made by the automobile manufacturers on the acoustic comfort of the motor-pump assembly, the outlet duct is arranged in such a way that air displaced out of the working chamber is conducted into an interior space, which surrounds the crank drive, of the pump housing, wherein an air outlet unit is provided which permits a quiet discharge of air from the interior space.

During the operation of the motor-pump assembly 3, however, undesired noises may also occur in the connecting line 6 between the pump and the vacuum-operated brake booster 2, which noises are amplified yet further by the vacuum-operated brake booster 2 and transmitted into the vehicle interior space. In particular, the increased use of vehicles with electric drive increases the demands made with regard to acoustics on the brake actuation unit 1 and on the motor-pump assembly 3.

To make allowance for said increasing demands with regard to acoustic comfort, it is the case in all of the exemplary embodiments described below that, to lower the sound pressure level in the vehicle interior space, a further silencer element 4, 4′, 4″ is provided in the connection between the vacuum-operated brake booster 2 and the pump, which further silencer element is either arranged directly at the vacuum inlet or a vacuum port 5 of the pump or, in an embodiment which is not illustrated, is integrated in the pump.

As a result of the integration of the further silencer element 4, 4′, 4″ in the pump, it is advantageously possible for a separate fastening to the motor-pump assembly 3 or to a further vehicle component to be dispensed with.

As a result of the arrangement of the further silencer element 4, 4′, 4″ at the vacuum port 5 of the pump, it is possible for pressure pulsations and oscillations in the connecting line 6, and noises generated as a result, to be prevented.

As can be seen from FIG. 1, in the first exemplary embodiment, there is provided as a further silencer element 4 a pressure equalization vessel 7 which permits a cross-sectional enlargement of the connecting line 6. Pressure pulsations and oscillations generated can be substantially eliminated by means of said cross-sectional enlargement.

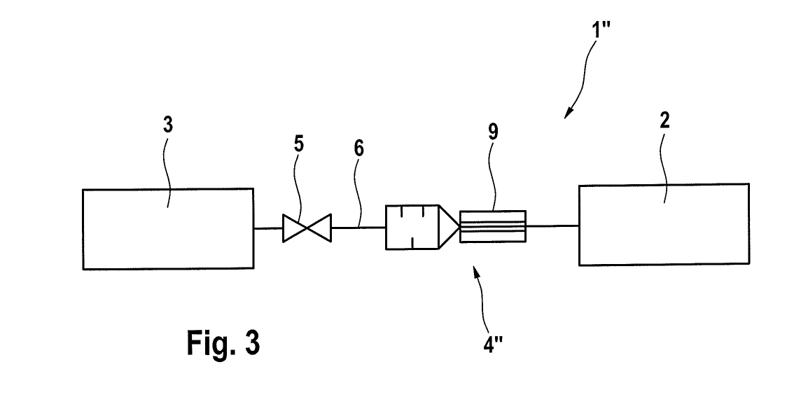

FIG. 2 shows a second exemplary embodiment of a brake actuation unit V according to the invention. As can be seen from said Fig., it is the case here that the further silencer element 4′ additionally has a Helmholtz resonator 8. The Helmholtz resonator 8 absorbs the disturbing frequency components, while the pressure equalization vessel 7 converts the remaining energy of the sound waves into heat by means of the friction.

An alternative embodiment as per FIG. 3 provides that the further silencer element 4″ additionally has a capillary tube 9. The disturbing frequency components can be absorbed by means of the cross-sectional variations of the connecting line 6 to be traversed by flow.

### LIST OF REFERENCE SYMBOLS

1 Brake actuation unit
1′ Brake actuation unit
1″ Brake actuation unit
2 Vacuum-operated brake booster
3 Motor-pump assembly
4 Further silencer element
4′ Further silencer element
4″ Further silencer element
5 Vacuum port
6 Connecting line
7 Pressure equalization vessel
8 Helmholtz resonator
9 Capillary tubes

What is claimed:

1. A brake actuation unit for a motor vehicle brake system, having a vacuum-operated brake booster and having a motor-pump assembly provided for generating negative pressure, comprising a pump which is connected to the vacuum-operated brake booster and comprising an electric motor which drives the pump, wherein the pump is provided in the form of a diaphragm pump with a pump housing and with at least one working diaphragm which, together with a working chamber cover, delimits a working chamber and which can be moved by means of a crank drive, wherein the working chamber is assigned an inlet duct with inlet valve and an outlet duct with outlet valve, and the outlet duct is arranged in such a way that air displaced out of the working chamber is conducted into an interior space, which surrounds the crank drive, of the pump housing, wherein an air outlet unit is provided which permits a quiet discharge of air from the interior space, wherein to lower the sound pressure level in the vehicle interior space, a further silencer element is provided in the connection between the vacuum-operated brake booster and the pump.

2. The brake actuation unit as claimed in claim 1, wherein a pressure equalization vessel is provided as the further silencer element.

3. The brake actuation device as claimed in claim 2, wherein the further silencer element additionally has a Helmholtz resonator.

4. The brake actuation unit as claimed in claim 2, wherein the further silencer element additionally has a capillary tube.

5. The brake actuation unit as claimed in claim 1, wherein the further silencer element is arranged directly at a vacuum inlet of the pump.

6. The brake actuation unit as claimed in claim 1, wherein the further silencer element is arranged in the pump.

7. The brake actuation unit as claimed in claim 1, wherein the pump is provided in the form of a double diaphragm pump with two opposite working diaphragms which are in each case clamped between a pump housing and a working chamber cover and thereby delimit the working chamber and which can be moved by means of the crank drive which has eccentrics and connecting rods.

8. A motor-pump assembly for generating negative pressure for a brake actuation unit of a motor vehicle brake system, having a vacuum-operated brake booster, a pump and an electric motor which drives the pump, wherein the pump is provided in the form of a diaphragm pump with a pump housing and with at least one working diaphragm which, together with a working chamber cover, delimits a working chamber and which can be moved by means of a crank drive, wherein the working chamber is assigned an inlet duct with inlet valve and an outlet duct with outlet valve, and the outlet duct is arranged in such a way that air displaced out of the working chamber is conducted into an interior space, which surrounds the crank drive, of the pump housing, wherein an air outlet unit is provided which permits a quiet discharge of air from the interior space, wherein a further silencer element is arranged directly at a vacuum inlet of the pump.

9. The motor-pump assembly as claimed in claim 8, wherein a pressure equalization vessel is provided as the further silencer element.

10. The motor-pump assembly as claimed in claim 9, wherein the further silencer element additionally has a Helmholtz resonator.

11. The motor-pump assembly as claimed in claim 10, wherein the further silencer element additionally has a capillary tube.
